(19) United States
(12) Patent Application Publication
(10) Pub. No.: US 2026/0299865 A1
(43) Pub. Date: Oct. 1, 2026

(54) DISPLAY METHOD AND DISPLAY DEVICE

(71) Applicants: Beijing BOE Display Technology Co., Ltd., Beijing (CN); BOE TECHNOLOGY GROUP CO., LTD., Beijing (CN)

(72) Inventors: Xiwang Xing, Beijing (CN); Rui Han, Beijing (CN); Qiannan Pan, Beijing (CN); Yongle Qi, Beijing (CN); Jie Yu, Beijing (CN); Xiaoqiao Dong, Beijing (CN); Pengtao Li, Beijing (CN); Tiantian Liu, Beijing (CN); Chunhua Wang, Beijing (CN); Xiaoxia Wang, Beijing (CN); Yang Wang, Beijing (CN); Qi Fu, Beijing (CN); Qing Ma, Beijing (CN); Daekeun Yoon, Beijing (CN); Site Cai, Beijing (CN); Biqi Li, Beijing (CN)

(73) Assignees: Beijing BOE Display Technology Co., Ltd., Beijing (CN); BOE TECHNOLOGY GROUP CO., LTD., Beijing (CN)

(21) Appl. No.: 19/477,563

(22) PCT Filed: Mar. 13, 2024
(86) PCT No.: PCT/CN2024/081506

§ 371 Date: Oct. 22, 2025

(30) Foreign Application Priority Data
Apr. 28, 2023 (CN) 202310485560.X

(51) Int. Cl. G09G 3/36; G09G 3/34; G09G 5/393; G09G 5/399

(52) U.S. Cl. CPC G06F 3/1431; G06F 1/1647; G06F 3/1423; G09G 3/3406; G09G 3/36; G09G 5/393; G09G 5/399; G06F 1/1649; G09G 2310/0297; G09G 2310/063; G09G 2310/08; G09G 2320/0247; G09G 2340/0435; G09G 2360/128; G09G 2380/10

(57) ABSTRACT

Provided are a display method and a display device. The display method is applied to the display device with a display panel. The display method includes: at a first stage, providing first display data to the display panel, so as to display a first image on a first display side of the display panel; and at a second stage, providing second display data to the display panel, so as to display a second image on a second display side of the display panel. The first display side and the second display side are arranged opposite to each other, and the first stage and the second stage occur alternately.

### CROSS-REFERENCE TO RELATED APPLICATIONS

The present application claims priority to Chinese patent application No. 202310485560.X, entitled “DISPLAY METHOD AND DISPLAY DEVICE”, filed on Apr. 28, 2023 before the China National Intellectual Property Administration, which is incorporated herein in its entirety by reference.

### TECHNICAL FIELD

The present disclosure relates to the field of display technology, and in particular to a display method and a display device.

### BACKGROUND

With the development of on-board control systems and the increase in vehicle functions, user requirements for on-board displays are gradually rising. On-board displays can provide users with the most intuitive experience, provide navigation information for drivers, and also provide movies, games and other entertainment information for passengers, thereby improving users' ride experience.

### SUMMARY

The present disclosure provides a display method applied to a display device with a display panel, and the display method includes:
at a first stage, providing first display data to the display panel to display a first image on a first display side of the display panel; and
at a second stage, providing second display data to the display panel to display a second image on a second display side of the display panel;
the first display side and the second display side are arranged opposite to each other, and the first stage and the second stage occur alternately.

In some embodiments, the first stage includes M frame periods, the first image is refreshed once within one frame period in the first stage, and M is greater than or equal to 1;
the second stage includes N frame periods, the second image is refreshed once within one frame period in the second stage, and N is greater than or equal to 1.

In some embodiments, M is equal to N.

In some embodiments, the display panel is a liquid crystal display (LCD) panel, and between the first stage and the second stage that are adjacent to each other, the method further comprises:
at a third stage, providing third display data to the display panel to display a black screen on an LCD panel in a normally black mode, or display a white screen on an LCD panel in a normally white mode.

In some embodiments, the third stage includes L frame periods, L being greater than 0, and less than or equal to 1.

In some embodiments, the display panel is a liquid crystal display (LCD) panel, the display device further includes a first backlight module and a second backlight module, the first backlight module is configured to provide backlight for the first display side, and the second backlight module is configured to provide backlight for the second display side;
steps in the first stage further include: controlling the first backlight module to be turned on, and controlling the second backlight module to be turned off;
steps in the second stage further include: controlling the second backlight module to be turned on, and controlling the first backlight module to be turned off.

In some embodiments, the first stage includes a first refresh phase and a first hold phase within the same frame period, and the second stage includes a second refresh phase and a second hold phase within the same frame period;
the step of providing the first display data to the display panel includes: providing the first display data to the display panel in the first refresh phase;
the step of controlling the first backlight module to be turned on includes: controlling the first backlight module to be turned on in the first hold phase;
the step of providing the second display data to the display panel includes: providing the second display data to the display panel in the second refresh phase;
the step of controlling the second backlight module to be turned on includes: controlling the second backlight module to be turned on in the second hold phase.

In some embodiments, the display device further includes a first buffer, a memory, and a driver chip, the first buffer is configured to buffer the first display data; before steps in the first stage, the method further includes:
detecting whether amount of the data in the first buffer meets a first write condition;
in response to detecting that the amount of the data in the first buffer meets the first write condition, generating a first write command, and writing the first display data in the first buffer into the memory according to the first write command, wherein the first display data in the memory is transmitted to the display panel through the driver chip in the first stage.

In some embodiments, the display device further includes a second buffer configured to buffer the second display data; after the step of detecting whether the amount of the data in the first buffer meets the first write condition and before steps in the second stage, the method further includes:
in response to detecting that the amount of the data in the first buffer does not meet the first write condition, detecting whether amount of the data in the second buffer meets a second write condition;
in response to detecting that the amount of the data in the second buffer meets the second write condition, generating a second write command, and writing the second display data in the second buffer into the memory according to the second write command, wherein the second display data in the memory is transmitted to the display panel through the driver chip in the second stage.

In some embodiments, after the step of detecting whether the amount of the data in the second buffer meets the second write condition, the method further includes:
in response to detecting that the amount of the data in the second buffer does not meet the second write condition, generating a read command, and reading the first display data or the second display data from the memory according to the read command.

In some embodiments, the display device further includes a command buffer and a data buffer;
the step of writing the first display data in the first buffer into the memory according to the first write command includes:
writing the first write command into the command buffer, and writing the first display data in the first buffer into the data buffer;
in response to detecting that a command is written into the command buffer, writing the first display data in the data buffer into the memory according to address and data volume in the first write command; and
the step of writing the second display data in the second buffer into the memory according to the second write command includes:
writing the second write command into the command buffer, and writing the second display data in the second buffer into the data buffer; and
in response to detecting that a command is written into the command buffer, writing the second display data in the data buffer into the memory according to the address and data volume in the second write command;
the step of reading the first display data or the second display data from the memory according to the read command includes:
writing the read command into the command buffer; and
in response to detecting that a command is written into the command buffer, reading the first display data or the second display data from the memory according to the address and data volume in the read command.

In some embodiments, the display device further includes a memory; before the first stage and the second stage, the method further includes:
writing data into a first storage zone and reading data from a second storage zone synchronously; or
reading data from the first storage zone and writing data into the second storage zone synchronously;
the first storage zone and the second storage zone are different storage zones in the memory.

The present disclosure provides a display device, including:
a display panel; and
a control module connected to the display panel, wherein the control module is configured to: provide first display data to the display panel in a first stage, and control a first image to be displayed on a first display side of the display panel; provide second display data to the display panel in a second stage, and control a second image to be displayed on a second display side of the display panel; wherein the first display side and the second display side are arranged opposite to each other, and the first stage and the second stage occur alternately.

In some embodiments, the display panel is a liquid crystal display (LCD) panel, and the display device further includes:
a first backlight module, configured to provide backlight to the first display side; and a second backlight module, configured to provide backlight to the second display side;
the control module is further configured to: control the first backlight module to be turned on and control the second backlight module to be turned off in the first stage; and control the second backlight module to be turned on and control the first backlight module to be turned off in the second stage.

In some embodiments, the control module includes a first backlight chip, a second backlight chip, and a main control chip;
wherein the first backlight chip is respectively connected to the main control chip and the first backlight module, and configured to: receive a first control signal sent from the main control chip, and control the first backlight module to be turned on or off in response to the first control signal;
the second backlight chip is respectively connected to the main control chip and the second backlight module, and configured to: receive a second control signal sent from the main control chip, and control the second backlight module to be turned on or off in response to the second control signal;
the main control chip is configured to send the first control signal to the first backlight chip and send the second control signal to the second backlight chip, based on the first control signal and the second control signal, the first backlight module is controlled to be turned on and the second backlight module to be turned off in the first stage, and the second backlight module is controlled to be turned on and the first backlight module to be turned off in the second stage.

In some embodiments, the control module further includes:
a driver chip connected to the main control chip and the display panel, wherein the driver chip is configured to: receive the first display data or the second display data output from the main control chip, and output the first display data or the second display data to the display panel according to a preset timing; and
a memory, connected to the main control chip, and configured to store the first display data and the second display data.

In some embodiments, the memory includes a first storage zone for storing the first display data and a second storage zone for storing the second display data.

In some embodiments, the first storage zone includes a first sub-zone and a second sub-zone, and the first display data for two adjacent first stages are respectively stored in the first sub-zone and the second sub-zone;
the second storage zone includes a third sub-zone and a fourth sub-zone, and the second display data for two adjacent second stages are respectively stored in the third sub-zone and the fourth sub-zone.

In some embodiments, a storage capacity of the first sub-zone, the second sub-zone, the third sub-zone, and the fourth sub-zone is a display data volume for one frame period.

In some embodiments, the memory is a double data rate synchronous dynamic random access memory.

The above description is only a general overview of solutions of the present disclosure. In order to learn technical means of the present disclosure more clearly and allow the technical means to be implemented based on the disclosure of the description, and in order to make the above and other objects, features and advantages of the present disclosure more apparent and understandable, specific embodiments of the present disclosure are illustrated below.

### BRIEF DESCRIPTION OF THE DRAWINGS

In order to describe technical solutions of the embodiments of the present disclosure or the related art more clearly, the accompanying drawings used in the illustration of the embodiments or the related art will be briefly introduced. Apparently, the accompanying drawings in the following explanation illustrate merely some embodiments of the present disclosure, and those skilled in the art may obtain other accompanying drawings based on these accompanying drawings without paying any creative effort. It should be noted that the scales in the accompanying drawings are for illustration only and do not represent actual scales.

FIG. 1 is a schematic connection diagram of a display device provided by the present disclosure;

FIG. 2 is a schematic connection diagram of a display device provided by the present disclosure;

FIG. 3 is a schematic connection diagram of a display device provided by the present disclosure;

FIG. 4 is a schematic flow diagram of a display method provided by the present disclosure;

FIG. 5 exemplarily shows two images displayed on both sides;

FIG. 6 exemplarily shows a timing diagram of display data and backlight control signals;

FIG. 7 exemplarily shows an internal connection diagram of a FPGA;

FIG. 8 exemplarily shows a work flow of an analysis module;

FIG. 9 exemplarily shows a flow of writing display data into a memory by a ping-pong read-write control module;

FIG. 10 shows a timing signal diagram generated according to timing requirements of the screen;

FIG. 11 shows a simulation diagram of timing signals generated, under control of a state machine, by using internal logic resources of a FPGA;

FIG. 12 is a schematic diagram showing ping-pong storage; and

FIG. 13 is a schematic diagram showing space division of a memory.

### DETAILED DESCRIPTION

To make objectives, technical solutions, and advantages of embodiments of the present disclosure clearer, a clear and thorough description for solutions in the embodiments of the present disclosure will be given below in conjunction with the accompanying drawings in the embodiments of the present disclosure. Apparently, the described embodiments are a part of embodiments of the present disclosure, not all the embodiments. All other embodiments obtained, based on the embodiments in the present disclosure, by those skilled in the art without paying creative effort fall within the protection scope of the present disclosure.

In the related technology, the limited interior space of a vehicle makes it difficult for the on-board display to meet both the navigation needs of the driver and the viewing needs of the passengers.

In the related technology, a parallax barrier or lenticular lens is generally used to guide the light from the odd and even pixel arrays into a set viewing zone, thereby enabling different images to be displayed from different viewing angles. This approach allows two distinct images to be shown simultaneously on the same screen, but each image is displayed at only half the screen's resolution.

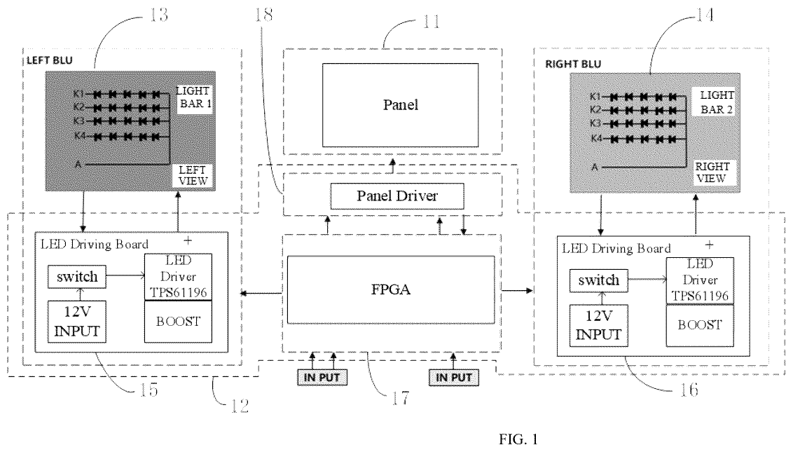

Referring to FIG. 1 to FIG. 3, schematic connection diagrams of several display devices provided by the disclosure are exemplarily shown. The display device includes a display panel 11 and a control module 12 connected to the display panel 11. The display method provided by the present disclosure can be executed by the control module 12 in the display device.

FIG. 4 is a flowchart of a display method provided by the present disclosure. As shown in FIG. 4, the display method includes steps described below.

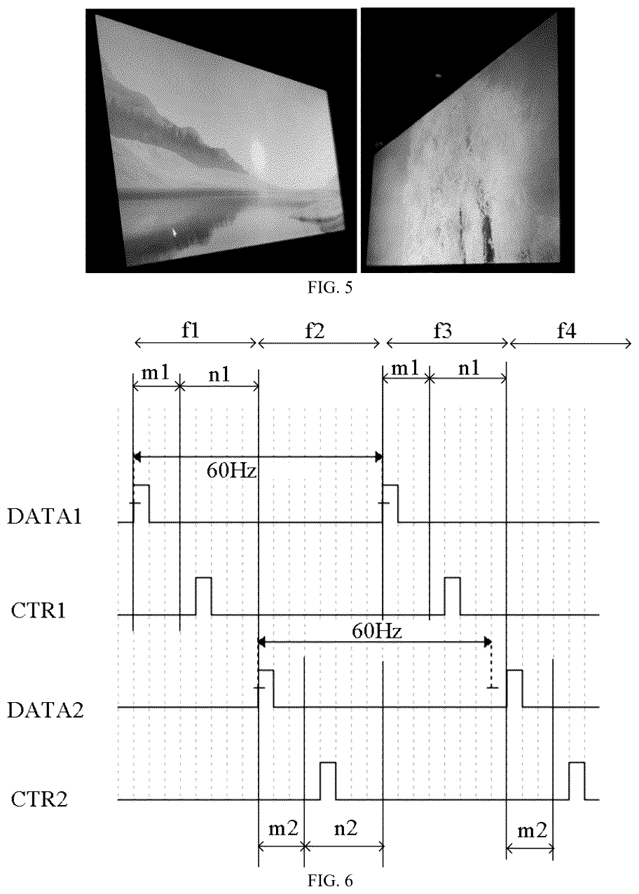

At step S01, at a first stage, first display data is provided to the display panel 11, enabling a first image to be displayed on a first display side of the display panel 11, as shown in the left picture in FIG. 5.

At step S02, at a second stage, second display data is provided to the display panel 11, enabling a second image to be displayed on a second display side of the display panel 11, as shown in the right picture in FIG. 5.

The first display side and the second display side are arranged opposite to each other, and the first stage and the second stage occur alternately.

According to the display method provided by the present disclosure, only the display image for one display side is output at a given moment, and the display image for the other display side is output at the next moment. That is, the display data of two images is alternately output and displayed on the same display panel. Thus, a bidirectional display effect can be achieved without reducing the resolution.

The display method provided by the present disclosure can be applied to on-board displays. For example, the first image can provide navigation information for the driver, while the second image can provide entertainment information for passengers. This enhances the driving or travel experience for users and enriches the functions of the vehicle system without compromising driving safety.

In specific implementation, to avoid the human eye perceiving flicker caused by refreshing, the refresh rate of the image displayed on a single side (such as the first image and the second image) can be greater than 60Hz. Accordingly, the screen refresh rate can be greater than 120 Hz.

In some embodiments, the first stage includes M frame periods (FRM). Within one frame period FRM in the first stage, the first image is refreshed once, where M is greater than or equal to 1; the second stage includes N frame periods (FRM). Within one frame period FRM in the second stage, the second image is refreshed once, where N is greater than or equal to 1.

In some embodiments, M is equal to N.

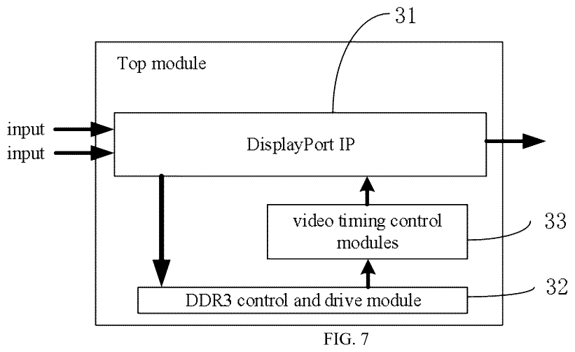

For example, when M=N=1, that is, when the first stage includes one frame period FRM, and the second stage includes one frame period FRM, the first image and the second image are output in manner of odd or even alternate frames. For instance, as shown in FIG. 6, the first image can be output in odd frames (such as the first frame f1, the third frame f3, etc.), and the second image can be output in even frames (such as the second frame f2, the fourth frame f4, etc.). Alternatively, the second image can be output in odd frames, and the first image can be output in even frames.

For example, when M=N=2, that is, when the first stage includes two frame periods FRM, and the second stage includes two frame periods FRM, the first image is output for two frames and then the second image is output for two frames in an alternating manner. For instance, the first image is output in the first frame and the second frame, the second image is output in the third frame and the fourth frame, the first image is output in the fifth frame and the sixth frame, and so on. Alternatively, the second image is output in the first frame and the second frame, the first image is output in the third frame and the fourth frame, the second image is output in the fifth frame and the sixth frame, and so on.

It should be noted that M does not necessarily have to be equal to N, which is not limited in the present disclosure.

In some embodiments, the display panel 11 is a liquid crystal display (LCD) panel. In the case, the display method further includes step S03 between adjacent first and second stages.

At step S03, at a third stage, third display data is provided to the display panel 11, enabling an LCD panel in normally black mode to display a black screen, or enabling an LCD panel in normally white mode to display a white screen.

In the third stage, the liquid crystal molecules in the LCD panel are restored to their initial state, i.e., the state where no electric field is applied. Crosstalk between the first image and the second image can be avoided by inserting the third stage between the first and second stages.

In some embodiments, the third stage includes L frame periods FRM, where L is greater than 0 and less than or equal to 1. That is, the duration of the third stage can be greater than 0 and less than or equal to one frame duration, which can be determined based on the actual display effect. In specific implementation, the duration of the third stage can also be greater than one frame duration, which is not limited in the present disclosure.

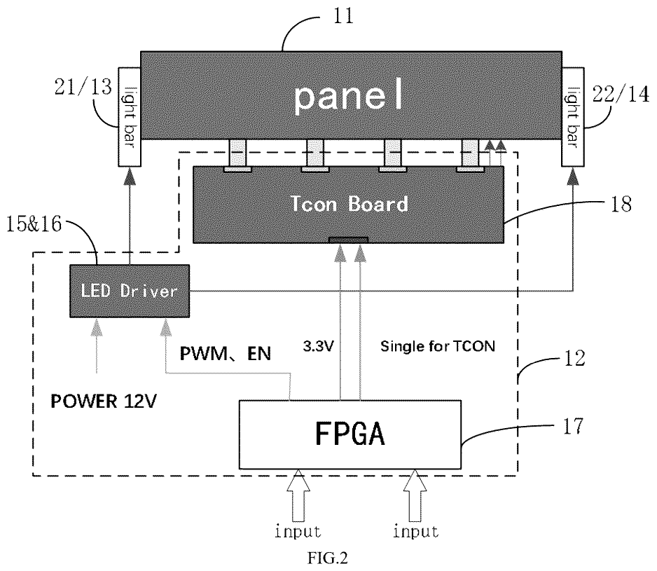

In some embodiments, the display panel 11 is an LCD panel, as shown in FIG. 1 or FIG. 2, the display device further includes a first backlight module 13 and a second backlight module 14. The first backlight module 13 is configured to provide backlight for the first display side, and the second backlight module 14 is configured to provide backlight for the second display side.

In this embodiment, step S01 can further include step S11.

At step S11, the first backlight module 13 is controlled to be turned on, and the second backlight module 14 is controlled to be turned off.

In this embodiment, step S02 can further include step S12.

At step S12, the second backlight module 14 is controlled to be turned on, and the first backlight module 13 is controlled to be turned off.

In this embodiment, the first backlight module 13 and the second backlight module 14 are driven in a time-division manner, ensuring that the first backlight module 13 provides backlight for the first display side only when the first image is output, and the second backlight module 14 provides backlight for the second display side only when the second image is output. This enables independent display on each side while preventing interference between the two displayed images.

In some embodiments, as shown in any of FIG. 1 to FIG. 3, the control module 12 can include a first backlight chip 15, a second backlight chip 16, and a main control chip 17. The first backlight chip 15 is connected to the main control chip 17 and the first backlight module 13. The first backlight chip 15 is configured to receive a first control signal sent by the main control chip 17, and control the first backlight module 13 to be turned on or turned off in response to the first control signal. The second backlight chip 16 is connected to the main control chip 17 and the second backlight module 14. The second backlight chip 16 is configured to receive a second control signal sent by the main control chip 17, and control the second backlight module 14 to be turned on or turned off in response to the second control signal. The main control chip 17 is configured to send the first control signal to the first backlight chip 15, and send the second control signal to the second backlight chip 16, so as to control the first backlight module 13 to be turned on and the second backlight module 14 to be turned off in the first stage, and control the second backlight module 14 to be turned on and the first backlight module 13 to be turned off in the second stage.

In some embodiments, the first stage includes a first refresh phase m1 and a first hold phase n1 within the same frame period FRM; the second stage includes a second refresh phase m2 and a second hold phase n2 within the same frame period FRM.

One frame period FRM can include a refresh phase and a hold phase. The refresh phase is a phase in which the data of the current frame is written, and the hold phase is a display holding phase after the data of the current frame is written and before data of the next frame is written.

In this embodiment, referring to FIG. 6, step S01, in which the first display data is provided to the display panel 11, can include: providing the first display data (such as the effective signal of DATA1 in FIG. 6) to the display panel 11 in the first refresh phase m1. Step S11, in which the first backlight module 13 is controlled to be enabled, includes: controlling the first backlight module 13 to be enabled in the first hold phase n1.

For example, in the first refresh phase m1, only data is written, and both the first backlight module 13 and the second backlight module 14 are turned off, so that no backlight is provided for the first display side and the second display side. In the first hold phase n1 after the data writing is completed, a first control signal (such as the effective signal of CTR1 in FIG. 6) for enabling the first backlight module 13 is provided to the first backlight chip 15, thereby providing backlight for the first display side. This prevents the residual image of the second image from appearing on the first display side.

In this embodiment, step S02, in which the second display data is provided to the display panel 11, can include: providing the second display data (such as the effective signal of DATA2 in FIG. 6) to the display panel 11 in the second refresh phase m2. Step S12, in which the second backlight module 14 is controlled to be turned on, can include: controlling the second backlight module 14 to be turned on in the second hold phase n2.

For example, in the second refresh phase m2, only data is written, and both the first backlight module 13 and the second backlight module 14 are turned off, so that no backlight is provided for the first display side and the second display side. In the second hold phase n2 after the data writing is completed, a second control signal (such as the effective signal of CTR2 in FIG. 6) for enabling the second backlight module 14 is provided to the second backlight chip 16, thereby providing backlight for the second display side. This prevents the residual image of the first image from appearing on the second display side.

In some embodiments, the main control chip 17 is also configured to receive the input of two display data (“INPUT” shown in FIG. 1 to FIG. 3), and output one display data at a certain time, that is, output the first display data or the second display data.

For example, the input format of the first display data and the second display data can both be 1080p60, that is, the image resolution is 1920×1080, and the frame rate is 60 Hz. The output format can be 1080p240, including a black screen at 120 Hz, the first image at 60 Hz, and the second image at 60 Hz.

A Field Programmable Gate Array (FPGA) is used as the main control chip 17 below for illustrative purposes. For example, the FPGA includes a Top module, a DisplayPort IP module 31, a DDR3 control and drive module 32, and a video timing control module 33. The connection structure of these four modules is shown in FIG. 7.

The DisplayPort IP module 31 can be provided by Intel. This DisplayPort IP module 31 supports a scalable main link with 1, 2, or 4 channels. Each channel has five optional data rates: 1.62 Gbps, 2.7 Gbps, 5.4 Gbps, 8.1 Gbps, and 10.0 Gbps. The main link can transmit video and audio streams through an embedded clock to separate the pixel and audio clocks from the transmission clock. The DisplayPort IP module 31 transmits the main link data in the DP1.4 scrambled ANSI 8B/10B format or the 128B/132B format in DP2.0, and the data transmission includes redundancy for error detection. For auxiliary data (such as audio), the DisplayPort IP module 31 uses Reed-Solomon encoding for error detection. The AUX channel in the DisplayPort IP module 31 consists of AC-coupled differential pairs. The AUX channel uses Manchester II encoding for channel encoding and provides a data rate of 1 Mbps. Each transaction takes less than 500 μs, and the maximum burst data size is 16 bytes.

The DDR3 control and drive module 32 includes a ping-pong read/write control module and a parsing module. The ping-pong read/write control module is configured to receive the two display data input through the DisplayPort IP module 31, and generate read/write commands. The parsing module is configured to perform corresponding read/write operations on the memory 31 according to the read/write commands. The data read from the memory 31 can then pass through the video timing control module 33 and the DisplayPort IP module 31 to be output from the main control chip 17.

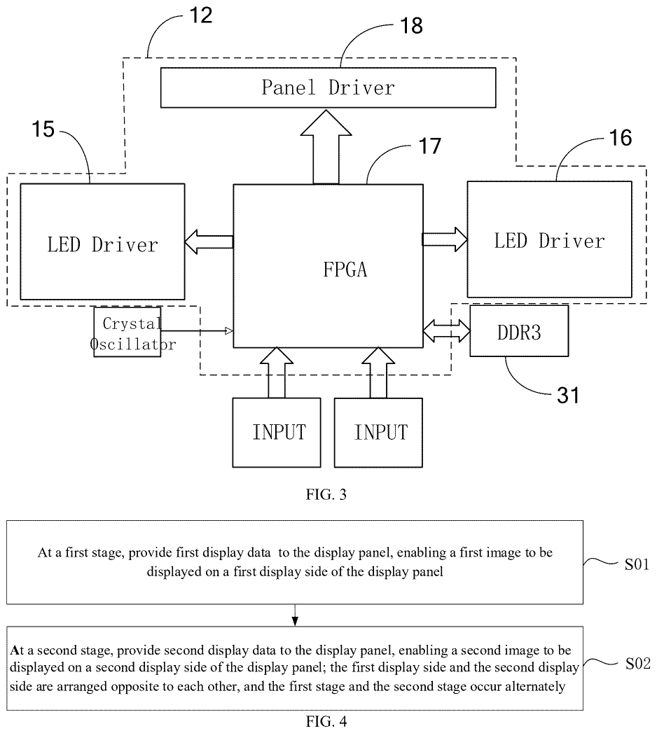

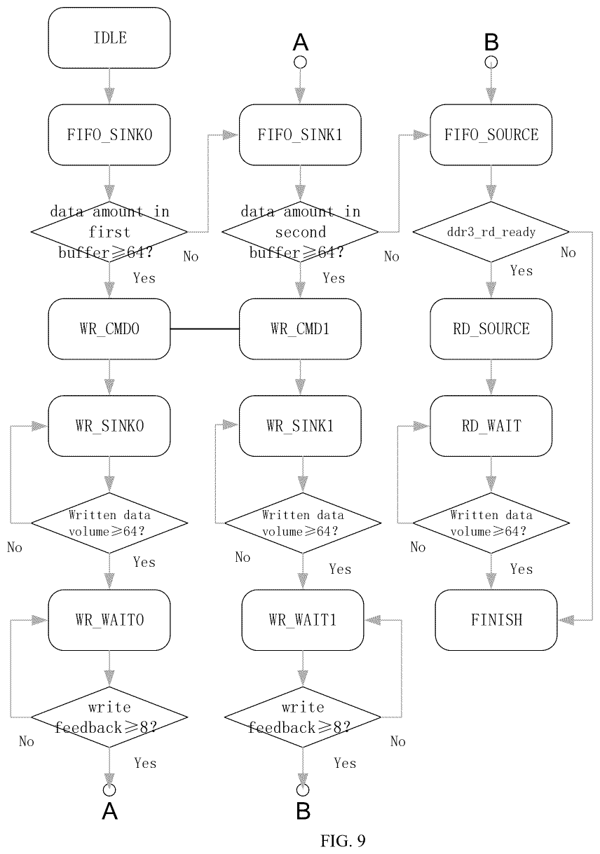

In some embodiments, as shown in FIG. 3, the display device further includes a first buffer, a memory 31, and a driver chip 18. The first buffer is configured to buffer the first display data. As shown in FIG. 9, the display method further includes steps S21 and S22 before step S01.

At step S21, it is detected whether the amount of data in the first buffer meets a first write condition.

For example, the first write condition can include that the amount of data in the first buffer is greater than or equal to a first preset data volume. The first preset data volume can be determined based on the display data volume of one frame period FRM. For example, the display data volume in one frame period FRM can be an integer multiple of the first preset data volume.

For example, for a display panel with a resolution of 1920×1080, the display data volume in one frame period FRM is 1920×1080=2,073,600 bytes. Accordingly, the first preset data volume can be set to 64 bytes.

For example, when the first preset data volume is 64 bytes, the amount of data in the first buffer (such as FIFO_SINK0 in FIG. 9) can be obtained first, and then it is determined whether the amount of data in the first buffer meets the first write condition (for example, whether the amount of data in the first buffer in FIG. 9 is greater than or equal to 64 bytes). If the amount of data in the first buffer is greater than or equal to 64 bytes, it can be determined that the first write condition is met. If the amount of data in the first buffer is less than 64 bytes, it can be determined that the first write condition is not met.

At step S22, if the first write condition is met, a first write command is generated, and the first display data in the first buffer is written into the memory 31 according to the first write command. The first display data in the memory 31 is transmitted to the display panel 11 through the driver chip 18 in the first stage.

That is, whenever the amount of data in the first buffer reaches the first preset data volume, a first write command can be executed.

For example, the first write command includes a first write data volume, which can be the first preset data volume. The first write command can further include a first write address, as well as a burst length and a command type, etc.

In the present disclosure, the write data volume may refer to the length of the data to be written, and the read data volume may refer to the length of the data to be read.

For example, the display device further includes a command buffer and a data buffer. Step S22 can include step S31 and step S32.

At step S31, the first write command is written into the command buffer, and the first display data in the first buffer is written into the data buffer.

At step S32, in response to detecting that a command is written into the command buffer, the first display data in the data buffer is written into the memory 31 according to the address and data volume in the first write command.

Referring to FIG. 9, WR_CMD0 represents writing the first write command into the command buffer of the parsing module, the first write command can include the first write address and the first write data volume. WR_SINK0 represents writing data of the “first write data volume” into the data buffer of the parsing module. During the write process, it is determined whether the amount of written data is greater than or equal to 64 bytes and whether there is a command is written into the command buffer. If not, WR_SINK0 continues to be executed. Otherwise, WR_WAIT0 is executed.

As shown in FIG. 9, WR_WAIT0 is for waiting for data to be written into the memory 31. During the waiting period, it is determined whether the write feedback is ≥8. If the write feedback is ≥8, the writing is completed; otherwise, the process returns to WR_WAIT0. For a data volume of 64 bytes, the parsing module needs to execute the storage process 8 times, with each storage process corresponding to one feedback. When all 64 bytes of data have been stored, there will be 8 feedbacks. Therefore, when the write feedback is greater than or equal to 8, it indicates that the writing is completed.

In some embodiments, the display device further includes a second buffer that is configured to buffer the second display data. After step S21 and before step S02, the display method can further include step S23 and step S24.

At step S23, if it is detected that the amount of data in the first buffer does not meet the first write condition, it is detected whether the amount of data in the second buffer meets a second write condition.

For example, the second write condition includes that the amount of data in the second buffer is greater than or equal to a second preset data volume. This second preset data volume can be determined based on the display data volume in one frame period FRM. For example, the display data volume in one frame period FRM can be an integer multiple of the second preset data volume.

For example, for a display panel with a resolution of 1920×1080, the display data volume in one frame period FRM is 1920×1080=2,073,600 bytes. Accordingly, the second preset data volume can be set to 64 bytes.

For example, when the second preset data volume is 64 bytes, the amount of data in the second buffer (such as FIFO_SINK1 in FIG. 9) can be obtained first, and then it is determined whether the amount of data in the second buffer meets the second write condition (for example, whether the amount of data in the second buffer is greater than or equal to 64 bytes shown in FIG. 9). If the amount of data in the second buffer is greater than or equal to 64 bytes, it can be determined that the second write condition is met. If the amount of data in the second buffer is less than 64 bytes, it can be determined that the second write condition is not met.

At step S24, if the second write condition is met, a second write command is generated, and the second display data in the second buffer is written into the memory 31 according to the second write command. The second display data in the memory 31 is transmitted to the display panel 11 through the driver chip 18 in the second stage.

That is, whenever the amount of data in the second buffer reaches the second preset data volume, a second write command can be executed.

For example, the second write command includes a second write data volume, which can be the second preset data volume. The second write command can further include a second write address, as well as a burst length and a command type, etc.

For example, step S24 can include step S33 and step S34.

At step S33, the second write command is written into the command buffer, and the second display data in the second buffer is written into the data buffer.

At step S34, in response to detected that a command is written into the command buffer, the second display data in the data buffer is written into the memory 31 according to the address and data volume in the second write command.

Referring to FIG. 9, WR_CMD1 represents writing the second write command into the command buffer of the parsing module, the second write command can include the second write address and the second write data volume. WR_SINK1 represents writing data of the “second write data volume” into the data buffer of the parsing module. During the writing process, it is determined whether the amount of written data is greater than or equal to 64 bytes and whether a command is written into the command buffer. If not, WR_SINK1 continues to be executed; otherwise, WR_WAIT1 is executed.

As shown in FIG. 9, WR_WAIT1 is for waiting for data to be written into the memory 31. During the waiting period, it is determined whether the write feedback is ≥8. If the write feedback is ≥8, the writing is completed; if not, the process returns to WR_WAIT1. For a data volume of 64 bytes, the parsing module needs to execute the storage process 8 times, with each storage process corresponding to one feedback. When all 64 bytes of data have been stored, there will be 8 feedbacks. Therefore, when the write feedback is greater than or equal to 8, it indicates that the writing is completed.

In some embodiments, after step S23, the display method can further include step S25.

At step S25, if it is detected that the amount of data in the second buffer does not meet the second write condition, a read command is generated, and, the first display data or the second display data is read from the memory 31 according to the read command.

For example, the read command includes a read data volume, which can be a third preset data volume. The third preset data volume can be determined based on the display data volume in one frame period FRM. For example, the display data volume in one frame period FRM can be an integer multiple of the third preset data volume.

For example, for a display panel with a resolution of 1920×1080, the display data volume in one frame period FRM is 1920×1080=2,073,600 bytes. Accordingly, the third preset data volume can be set to 64 bytes.

The read command can further include a read address, as well as a burst length and a command type, etc.

Referring to FIG. 9, FIFO_SOURCE represents generating a read command.

DDR3_RD_READY indicates preparation for read operations. After the read command is generated, a check is performed to determine whether it is ready for reading. If it is ready for reading, the first display data or the second display data is read from the memory 31 according to the read command. If it is not ready for reading, the process ends.

For example, step S25 can include step S35 and step S36.

At step S35, the read command is written into the command buffer.

At step S36, in response to detecting that a command is written into the command buffer, the first display data or the second display data is read from the memory 31 according to the address and data volume in the read command.

Referring to FIG. 9, RD_SOURCE represents writing the read command into the command buffer of the parsing module, the read command can include the read address and the read data volume (i.e., the third preset data volume, for example 64 bytes). RD_WAIT represents waiting for data to be read out from the memory 31. During the waiting period, it is determined whether the volume of the data that has been read is greater than or equal to 64 bytes. If the volume of the data that has been read is greater than or equal to 64 bytes, the reading completes, and the process ends. Otherwise, the process returns to RD_WAIT.

As shown in FIG. 9, after the process ends, for example, IDLE can be re-executed to start the next cycle. By cyclically executing steps S21 to S25, it can ensure that the display data is not lost, and display data can be continuously output to the display panel, thereby driving the display panel to perform single-side display.

For example, the first buffer, the second buffer, the command buffer, and the data buffer can be First Input First Output (FIFO) memory, which is not limited in the present disclosure.

For example, the first buffer and the second buffer can be located in the ping-pong read/write control module; the command buffer and the data buffer can be located in the parsing module.

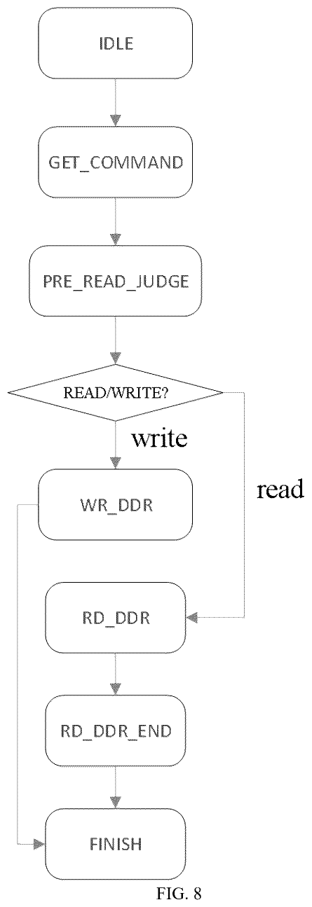

Referring to FIG. 8, firstly, the parsing module can determine whether there is a command in the command buffer. If there is a command in the command buffer, the command is read from the command buffer (GET_COMMAND as shown in FIG. 8). Then, the command type is determined (PRE_READ_JUDGE as shown in FIG. 8), that is, determining whether the command type is READ or WRITE. If the command type is READ, the operation of reading from the memory DDR3 is performed (RD_DDR in FIG. 8) until the read ends (RD_DDR_END in FIG. 8). If the command type is WRITE, the operation of writing to the memory DDR3 is performed (WR_DDR in FIG. 8).

For example, the memory 31 can be Double Data Rate Synchronous Dynamic Random Access Memory, such as DDR3 memory. The present disclosure does not limit this aspect.

For example, the timing controller, the driver chip 18, and the backlight chip are all chips that support high refresh rates. The refresh rate may be greater than or equal to 60 Hz, or even reaches 2400 Hz.

In some embodiments, as shown in any of FIG. 1 to FIG. 3, the display device also includes the memory 31. Before steps S01 and S02, the display method can further include step S41 or step S42.

At step S41, the steps of writing data into the first storage zone and the step of reading data from the second storage zone are executed simultaneously.

At step S42, the steps of reading data from the first storage zone and the step of writing data into the second storage zone are executed simultaneously. The first storage zone and the second storage zone are different storage areas in the memory 31.

Since DDR3 memory cannot read and write simultaneously, that is, it cannot read data from the first storage zone while writing data into the first storage zone, and similarly, it cannot read data from the second storage zone while writing data into the second storage zone.

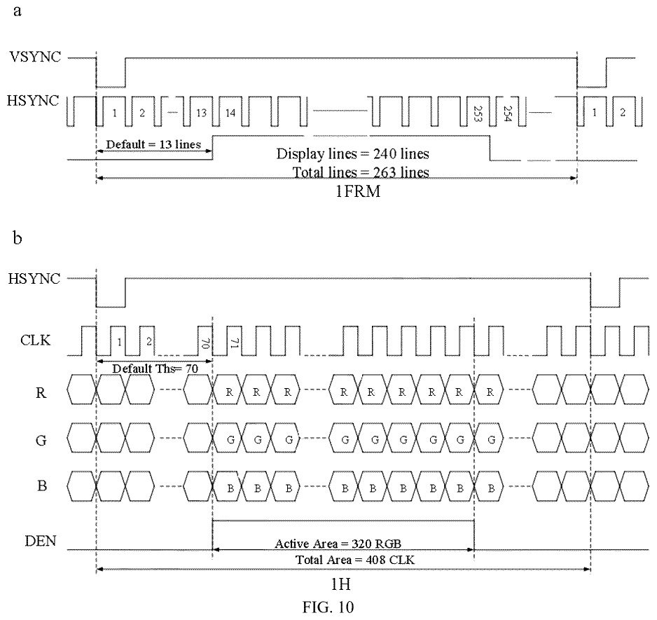

FIG. 10 shows the timing signal diagrams generated according to screen timing requirements, graph a of FIG. 10 includes a vertical synchronization signal (VSYNC) and a horizontal synchronization signal (HSYNC) within a frame period (FRM), and graph b of FIG. 10 includes the horizontal synchronization signal (HSYNC), a pixel clock signal (CLK), RGB display data, and data enable signal (DEN) within a line scan period (1H).

FIG. 11 shows the timing signal simulation diagram generated by controlling the state machine according to the internal logic resources of the FPGA, including the vertical synchronization signal (VSYNC), the horizontal synchronization signal (HSYNC), RGB data, and data enable signal (DEN).

The display method provided by the present disclosure involves a code design part that can be completed in Quartus Prime Pro. Using the Quartus Prime Pro integrated development environment, an image transmission IP is established by leveraging the NIOS II, an embedded reduced instruction set CPU, along with system components and peripheral devices. Moreover, Quartus Prime Pro is also responsible for completing code compilation, synthesis, and layout routing, etc., to finish the hardware platform design. The software programming part can be completed in the NIOS II software build Tools, mainly responsible for driver part of the Display Port.

The present disclosure further provides a display device. As shown in any of FIG. 1 to FIG. 3, the display device includes a display panel 11 and a control module 12 connected to the display panel 11. The control module 12 is configured to: provide the first display data to the display panel 11 in the first stage, control the first image to be displayed on the first display side of the display panel 11; and provide the second display data to the display panel 11 in the second stage, control the second image to be displayed on the second display side of the display panel 11. The first display side and the second display side are arranged opposite to each other, and the first stage and the second stage occur alternately.

Those skilled in the art can understand that the display device provided by the present disclosure has the advantages of the aforementioned display method. The display device provided by the present disclosure can be integrated into products such as laptops, monitors, and can be used as a display screen in many fields such as on-board display and consumer electronics.

Regarding the display device, the specific operations of the control module 12 has already been described in detail in the implementation of the display method, and will not be elaborated here.

In some embodiments, as shown in any of FIG. 1 to FIG. 3, the display panel 11 is a liquid crystal display panel. The display device further includes: a first backlight module 13, configured to provide backlight for the first display side; and a second backlight module 14, configured to provide backlight for the second display side. Correspondingly, the control module 12 is further configured to: control the first backlight module 13 to be turned on and the second backlight module 14 to be turned off in the first stage; and control the second backlight module 14 to be turned on and the first backlight module 13 to be turned off in the second stage.

In some embodiments, as shown in any of FIG. 1 to FIG. 3, the control module 12 includes: a first backlight chip 15, a second backlight chip 16, and a main control chip 17.

The first backlight chip 15 is connected to the main control chip 17 and the first backlight module 13. The first backlight chip 15 is configured to receive the first control signal sent by the main control chip 17, and control the first backlight module 13 to be turned on or off in response to the first control signal.

The second backlight chip 16 is connected to the main control chip 17 and the second backlight module 14. The second backlight chip 16 is configured to receive the second control signal sent by the main control chip 17, and control the second backlight module 14 to be turned on or off in response to the second control signal.

The main control chip 17 is configured to send the first control signal to the first backlight chip 15 and send the second control signal to the second backlight chip 16, thereby controlling the first backlight module 13 to be turned on and the second backlight module 14 to be turned off in the first stage, and controlling the second backlight module 14 to be turned on and the first backlight module 13 to be turned off in the second stage.

The first control signal and the second control signal can include pulse width modulation signals (PWM) and enable signals (EN), etc.

For example, the first backlight module 13 can include a first light bar 21 disposed on a side surface of the display panel 11, and optical films such as light guide plates that can direct the light emitted by the first light bar 21 towards the first display side.

For example, the second backlight module 14 can include a second light bar 22 disposed on the other side surface of the display panel 11, and optical films such as light guide plates that can direct the light emitted by the second light bar 22 towards the second display side.

For example, the main control chip 17 can include at least one of the following: Central Processing Unit (CPU), Microcontroller Unit (MCU), and Field Programmable Gate Array (FPGA), etc, which is not limited in this embodiment.

To reduce heat generation caused by high power output from the FPGA, the first backlight module 13 and the second backlight module 14 can be powered independently, thereby minimizing product heating.

In some embodiments, as shown in any of FIG. 1 to FIG. 3, the control module 12 further includes: a driver chip 18, connected to the main control chip 17 and the display panel 11, configured to receive the first display data or the second display data output from the main control chip 17, and output the first display data or the second display data to the display panel 11 according to a preset timing.

In some embodiments, as shown in FIG. 3, the control module 12 further includes a memory 31 for storing the first display data and the second display data, and the memory 31 is connected to the main control chip 17.

In this embodiment, the occupation of the FPGA storage resources can be effectively reduced by writing the first display data and the second display data into an external memory 31, and data loss can be avoided.

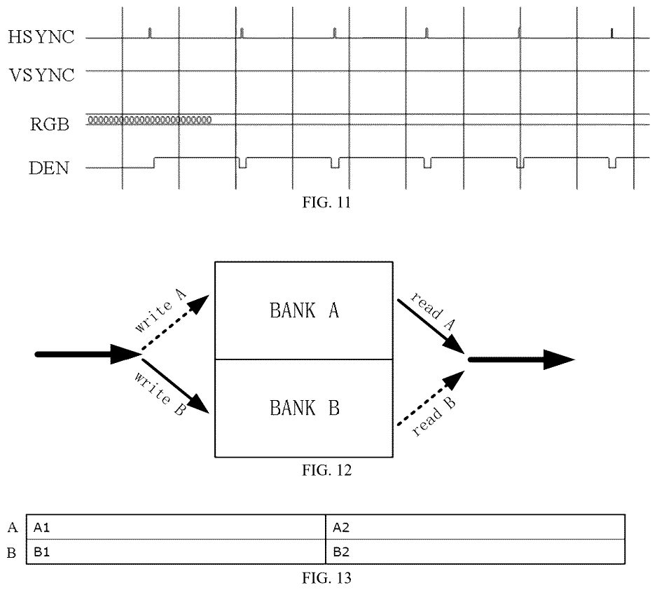

In some embodiments, as shown in FIG. 12, the memory 31 includes a first storage zone A for storing the first display data and a second storage zone B for storing the second display data.

In this embodiment, by writing the first display data and the second display data into different storage zones of the memory 31, the storage bandwidth of the memory 31 can be maximized.

In some embodiments, as shown in FIG. 13, the first storage zone A includes a first sub-zone A1 and a second sub-zone A2, the first display data of two adjacent first stages are respectively stored in the first sub-zone A1 and the second sub-zone A2; the second storage zone B includes a third sub-zone B1 and a fourth sub-zone B2, the second display data of two adjacent second stages are respectively stored in the third sub-zone B1 and the fourth sub-zone B2.

For example, first, the first display data can be written into the first sub-zone A1, and the second display data can be written into the third sub-zone B1 (the writing process of the first sub-zone A1 and the writing process of the third sub-zone B1 are independent of each other and do not interfere with each other); meanwhile, the first display data is read from the second sub-zone A2 first, after the read is completed, the second display data is read from the fourth sub-zone B2.

In this way, after the first sub-zone A1 and the third sub-zone B1 are filled with data, the data in the second sub-zone A2 and the fourth sub-zone B2 is read out. When the next write command is executed, the data write zone needs to be switched from the first sub-zone A1 and the third sub-zone B1 to the second sub-zone A2 and the fourth sub-zone B2; when the next read command is executed, the data read zone needs to be switched from the second sub-zone A2 and the fourth sub-zone B2 to the first sub-zone A1 and the third sub-zone B1. That is, the first display data of two adjacent first stages are stored in the first sub-zone A1 and the second sub-zone A2 respectively, and the second display data of two adjacent second stages are stored in the third sub-zone B1 and the fourth sub-zone B2 respectively.

Afterwards, the first display data can be written into the second sub-zone A2, and the second display data can be written into the fourth sub-zone B2 (the writing process of the second sub-zone A2 and the writing process of the fourth sub-zone B2 are independent of each other without interfering with each other); meanwhile, the first display data is read from the first sub-zone A1 first, after the reading is completed, the second display data is read from the third sub-zone B1.

It should be noted that the above-mentioned written first display data and the read first display data may be display data of the first image in the same frame or different frames, and the above-mentioned written second display data and the read second display data may be display data of the second image in the same frame or different frames.

FIG. 12 is a schematic diagram showing ping-pong storage, where two solid arrows represent processes executed simultaneously at one moment, and two dashed arrows represent processes executed simultaneously at another moment. The simultaneous execution here refers to the execution process of the hardware of the memory 31.

As shown in FIG. 12, the storage space of the memory 31 is divided into two parts: a first storage zone A and a second storage zone B. When the FPGA receives a command to write display data into the memory 31, the first channel of display data is written into the first storage zone A, and at the same time, the data in the second storage zone B is read; then the second channel of display data is written into the second storage zone B, and at the same time, the data in the first storage zone A is read . . . Such cyclic reading and writing can reduce the use of internal storage resources of the FPGA and make full use of the advantage of the fast reading and writing speed of the memory 31.

The ping-pong storage method adopted in this embodiment can make full use of the bandwidth of the DDR3 memory on the premise of ensuring the continuity of input and output data.

In some embodiments, the storage capacity of the first sub-zone A1, the second sub-zone A2, the third sub-zone B1, and the fourth sub-zone B2 is the display data volume for one frame period (FRM).

In some embodiments, the memory 31 is a double data rate synchronous dynamic random access memory (DDR SDRAM), such as a DDR3 memory.

In some embodiments, the display panel may be a self-luminous display panel, which has a built-in light-emitting device. Examples of the light-emitting device include an Organic Light-Emitting Diode (OLED), a Quantum Dot Light-Emitting Diode (QLED), a Mini Light-Emitting Diode (Mini LED), a Micro Light-Emitting Diode (Micro LED), and the like.

In the present disclosure, the term “plurality” means two or more, and the term “at least one” means one or more, unless otherwise clearly and specifically defined.

In the present disclosure, orientation or positional relationships indicated by terms such as “upper” and “lower” are based on the orientation or positional relationships shown in the accompanying drawings, which are only for the convenience of describing the present disclosure and simplifying the description, rather than indicating or implying that the referred device or element must have a specific orientation, be constructed and operated in a specific orientation, and therefore cannot be understood as a limitation on the present disclosure.

In this document, the terms “include”, “comprise” or any other variants thereof are intended to cover non-exclusive inclusion, so that a process, method, article, or device including a series of elements not only includes those elements but also includes other elements not explicitly listed, or further includes elements inherent to such a process, method, article, or device. Without more restrictions, an element defined by the sentence “including one . . . ” does not exclude the existence of other identical elements in the process, method, article, or device that includes the element.

The terms “one embodiment”, “some embodiments”, “exemplary embodiments”, “one or more embodiments”, “example”, “one example”, “some examples” and the like referred to in this document are intended to indicate that a specific feature, structure, material, or characteristic related to the embodiment or example is included in at least one embodiment or example of the present disclosure. The schematic representations of the above terms do not necessarily refer to the same embodiment or example. In addition, the specific features, structures, materials, or characteristics described may be included in any one or more embodiments or examples in any appropriate manner.

Relational terms such as “first” and “second” herein are used merely to distinguish one entity or operation from another entity or operation, and do not necessarily require or imply that there is any such actual relationship or sequence between these entities or operations.

In describing some embodiments, the expressions “coupled” and “connected” may be used. For example, the term “connected” may be used in describing some embodiments to indicate that two or more components are in direct physical or electrical contact with each other. For another example, the term “coupled” may be used in describing some embodiments to indicate that two or more components are in direct physical or electrical contact with each other. However, the term “coupled” or “communicatively coupled” may also refer to a state where two or more components are not in direct contact with each other, but still cooperate or interact with each other. The embodiments disclosed herein are not necessarily limited to the content of this document.

“At least one of A, B, and C” has the same meaning as “at least one of A, B, or C”, and both include the following combinations: only A, only B, only C, a combination of A and B, a combination of A and C, a combination of B and C, and a combination of A, B, and C.

“A and/or B” includes the following three combinations: only A, only B, and a combination of A and B.

As used herein, depending on the context, the term “if” is optionally interpreted to mean “when” or “upon” or “in response to determining” or “in response to detecting”. Similarly, depending on the context, the phrases “if it is determined that . . . ” or “if [the stated condition or event] is detected” are optionally interpreted to mean “when it is determined that . . . ” or “in response to determining that . . . ” or “when [the stated condition or event] is detected” or “in response to detecting [the stated condition or event]”.

The use of “for” or “configured to” herein denotes open and inclusive language, which does not exclude devices that are suitable for or configured to perform additional tasks or steps.

The use of “based on” or “according to” herein denotes open and inclusiveness. A process, step, calculation, or other action based on one or more of the stated conditions or values may, in practice, be based on other conditions or exceed the stated values. A process, step, calculation, or other action according to one or more of the stated conditions or values may, in practice, be according to other conditions or exceed the stated values.

As used herein, “about”, “approximately”, or “roughly” includes the stated value and an average value within an acceptable deviation range of the specific value, where the acceptable deviation range is determined by a person of ordinary skill in the art considering the measurement in question and the error associated with the measurement of the specific quantity (i.e., the limitations of the measurement system).

As used herein, “parallel”, “perpendicular”, “equal”, and “flush” include the stated situation and situations approximate to the stated situation, where the range of the approximate situations falls within an acceptable deviation range. The acceptable deviation range is determined by a person of ordinary skill in the art considering the measurement in question and the error associated with the measurement of the specific quantity (i.e., the limitations of the measurement system). For example, “parallel” includes absolute parallelism and approximate parallelism, where the acceptable deviation range for approximate parallelism may be, for example, a deviation within 5 degrees; “perpendicular” includes absolute perpendicularity and approximate perpendicularity, where the acceptable deviation range for approximate perpendicularity may also be, for example, a deviation within 5 degrees. “Equal” includes absolute equality and approximate equality, where the acceptable deviation range for approximate equality may be, for example, that the difference between the two equal quantities is less than or equal to 5% of either of them. “Flush” includes absolute flushness and approximate flushness, where the acceptable deviation range for approximate flushness may be, for example, that the distance between the two flush components is less than or equal to 5% of the size of either of them.

It should be understood that when a layer or element is referred to as being “on” another layer or substrate, it can be directly on the other layer or substrate, or there may be an intermediate layer between the layer or element and the other layer or substrate.

Exemplary embodiments are described herein with reference to cross-sectional views and/or plan views that are idealized exemplary drawings. In the drawings, the thicknesses of layers and regions are exaggerated for clarity. Therefore, variations in shape relative to the drawings due to, for example, manufacturing techniques and/or tolerances are conceivable. Thus, the exemplary embodiments should not be construed as being limited to the shapes of the regions shown herein, but rather include shape deviations caused by, for example, manufacturing. For example, an etched region shown as a rectangle will typically have rounded features. Therefore, the regions shown in the drawings are schematic in nature, and their shapes are not intended to illustrate the actual shape of the regions of a device and are not intended to limit the scope of the exemplary embodiments.

Finally, it should be noted that the above embodiments are only used to illustrate the technical solutions of the present disclosure, but not to limit them; although the present disclosure has been described in detail with reference to the foregoing embodiments, those skilled in the art should understand that he or she can still modify the technical solutions recorded in the foregoing embodiments, or equivalently replace some of the technical features therein; and such modifications or replacements do not cause the essence of the corresponding technical solutions to deviate from the spirit and scope of the technical solutions of the embodiments of the present disclosure.

1. A display method, applied to a display device with a display panel, the display method comprises:
at a first stage, providing first display data to the display panel to display a first image on a first display side of the display panel; and
at a second stage, providing second display data to the display panel to display a second image on a second display side of the display panel;
wherein the first display side and the second display side are arranged opposite to each other, and the first stage and the second stage occur alternately.

2. The display method according to claim 1, wherein the first stage comprises M frame periods, the first image is refreshed once within one frame period in the first stage, and M is greater than or equal to 1;
the second stage comprises N frame periods, the second image is refreshed once within one frame period in the second stage, and N is greater than or equal to 1.

3. The display method according to claim 2, wherein M is equal to N.

4. The display method according to claim 1, wherein the display panel is a liquid crystal display (LCD) panel, and between the first stage and the second stage that are adjacent to each other, the method further comprises:
at a third stage, providing third display data to the display panel to display a black screen on an LCD panel in a normally black mode, or display a white screen on an LCD panel in a normally white mode.

5. The display method according to claim 4, wherein the third stage comprises L frame periods, L being greater than 0, and less than or equal to 1.

6. The display method according to claim 1, wherein the display panel is a liquid crystal display (LCD) panel, the display device further comprises a first backlight module and a second backlight module, the first backlight module is configured to provide backlight for the first display side, and the second backlight module is configured to provide backlight for the second display side; wherein
steps in the first stage further comprise: controlling the first backlight module to be turned on, and controlling the second backlight module to be turned off;
steps in the second stage further comprise: controlling the second backlight module to be turned on, and controlling the first backlight module to be turned off.

7. The display method according to claim 6, wherein the first stage comprises a first refresh phase and a first hold phase within the same frame period, and the second stage comprises a second refresh phase and a second hold phase within the same frame period;
the step of providing the first display data to the display panel comprises: providing the first display data to the display panel in the first refresh phase;
the step of controlling the first backlight module to be turned on comprises: controlling the first backlight module to be turned on in the first hold phase;
the step of providing the second display data to the display panel comprises: providing the second display data to the display panel in the second refresh phase;
the step of controlling the second backlight module to be turned on comprises: controlling the second backlight module to be turned on in the second hold phase.

8. The display method according to claim 1, wherein the display device further comprises a first buffer, a memory, and a driver chip, the first buffer is configured to buffer the first display data; before steps in the first stage, the method further comprises:
detecting whether amount of the data in the first buffer meets a first write condition;
in response to detecting that the amount of the data in the first buffer meets the first write condition, generating a first write command, and writing the first display data in the first buffer into the memory according to the first write command, wherein the first display data in the memory is transmitted to the display panel through the driver chip in the first stage.

9. The display method according to claim 8, wherein the display device further comprises a second buffer configured to buffer the second display data; after the step of detecting whether the amount of the data in the first buffer meets the first write condition and before steps in the second stage, the method further comprises:
in response to detecting that the amount of the data in the first buffer does not meet the first write condition, detecting whether amount of the data in the second buffer meets a second write condition;
in response to detecting that the amount of the data in the second buffer meets the second write condition, generating a second write command, and writing the second display data in the second buffer into the memory according to the second write command, wherein the second display data in the memory is transmitted to the display panel through the driver chip in the second stage.

10. The display method according to claim 9, wherein after the step of detecting whether the amount of the data in the second buffer meets the second write condition, the method further comprises:
in response to detecting that the amount of the data in the second buffer does not meet the second write condition, generating a read command, and reading the first display data or the second display data from the memory according to the read command.

11. The display method according to claim 10, wherein the display device further comprises a command buffer and a data buffer;
the step of writing the first display data in the first buffer into the memory according to the first write command comprises:
writing the first write command into the command buffer, and writing the first display data in the first buffer into the data buffer;
in response to detecting that a command is written into the command buffer, writing the first display data in the data buffer into the memory according to address and data volume in the first write command; and
the step of writing the second display data in the second buffer into the memory according to the second write command comprises:
writing the second write command into the command buffer, and writing the second display data in the second buffer into the data buffer; and
in response to detecting that a command is written into the command buffer, writing the second display data in the data buffer into the memory according to the address and data volume in the second write command;
the step of reading the first display data or the second display data from the memory according to the read command comprises:
writing the read command into the command buffer; and
in response to detecting that a command is written into the command buffer, reading the first display data or the second display data from the memory according to the address and data volume in the read command.

12. The display method according to claim 1, wherein the display device further comprises a memory; before the first stage and the second stage, the method further comprises:
writing data into a first storage zone and reading data from a second storage zone synchronously; or
reading data from the first storage zone and writing data into the second storage zone synchronously;
wherein the first storage zone and the second storage zone are different storage zones in the memory.

13. A display device, comprising:
a display panel; and
a control module connected to the display panel, wherein the control module is configured to: provide first display data to the display panel in a first stage, and control a first image to be displayed on a first display side of the display panel; provide second display data to the display panel in a second stage, and control a second image to be displayed on a second display side of the display panel;
wherein the first display side and the second display side are arranged opposite to each other, and the first stage and the second stage occur alternately.

14. The display device according to claim 13, wherein the display panel is a liquid crystal display (LCD) panel, and the display device further comprises:
a first backlight module, configured to provide backlight to the first display side; and
a second backlight module, configured to provide backlight to the second display side;
wherein the control module is further configured to: control the first backlight module to be turned on and control the second backlight module to be turned off in the first stage; and control the second backlight module to be turned on and control the first backlight module to be turned off in the second stage.

15. The display device according to claim 14, wherein the control module comprises a first backlight chip, a second backlight chip, and a main control chip;
wherein the first backlight chip is respectively connected to the main control chip and the first backlight module, and configured to: receive a first control signal sent from the main control chip, and control the first backlight module to be turned on or off in response to the first control signal;
the second backlight chip is respectively connected to the main control chip and the second backlight module, and configured to: receive a second control signal sent from the main control chip, and control the second backlight module to be turned on or off in response to the second control signal;
the main control chip is configured to send the first control signal to the first backlight chip and send the second control signal to the second backlight chip, based on the first control signal and the second control signal, the first backlight module is controlled to be turned on and the second backlight module to be turned off in the first stage, and the second backlight module is controlled to be turned on and the first backlight module to be turned off in the second stage.

16. The display device according to claim 15, wherein the control module further comprises:
a driver chip connected to the main control chip and the display panel, wherein the driver chip is configured to: receive the first display data or the second display data output from the main control chip, and output the first display data or the second display data to the display panel according to a preset timing; and
a memory, connected to the main control chip, and configured to store the first display data and the second display data.

17. The display device according to claim 16, wherein the memory comprises a first storage zone for storing the first display data and a second storage zone for storing the second display data.

18. The display device according to claim 17, wherein the first storage zone comprises a first sub-zone and a second sub-zone, and the first display data for two adjacent first stages are respectively stored in the first sub-zone and the second sub-zone;
the second storage zone comprises a third sub-zone and a fourth sub-zone, and the second display data for two adjacent second stages are respectively stored in the third sub-zone and the fourth sub-zone.

19. The display device according to claim 18, wherein a storage capacity of the first sub-zone, the second sub-zone, the third sub-zone, and the fourth sub-zone is a display data volume for one frame period.

20. The display device according to claim 16, wherein the memory is a double data rate synchronous dynamic random access memory.
